(19) United States
(12) Patent Application Publication
(10) Pub. No.: US 2009/0024547 A1
(43) Pub. Date: Jan. 22, 2009

(54) MULTI-INTELLIGENT SYSTEM FOR TOXICOGENOMIC APPLICATIONS (MISTA)

(75) Inventors: Po-Yung Lu, Oak Ridge, TN (US); Bobby G. Sumpter, Knoxville, TN (US); John S. Wassom, Rockwood, TN (US); Sheryl A. Martin, Louisville, TN (US); Pamela L. Piotrowski, Annapolis, MD (US); Donald W. Noid, Marshall, IA (US)

Correspondence Address: AKERMAN SENTERFITT, P.O. BOX 3188, WEST PALM BEACH, FL, 33402-3188, US

(73) Assignee: UT-Battelle, LLC, Oak Ridge, TN (US)

(21) Appl. No.: 11/779,186

(22) Filed: Jul. 17, 2007

(51) Int. Cl. G06F 15/18

(52) U.S. Cl. 706/21

(57) ABSTRACT

A system (100) and method (800) to predict toxicological effects of molecules is provided. The method can include obtaining (802) a three-dimensional (3-D) structure of a molecule from a database, transforming (804) the 3-D structure to a one-dimensional (1-D) geometrical representation using a combination of a molecular transform (114) and wavelet transform (115), computing a topology and electronic structure of the molecule via topological indices, and generating a feature vector (500) comprising the 1-D geometrical representation (510), and the topology and the electronic structure (520). The system can predict at least one among metabolic processes, modes of action, hepatotoxicity, and neurotoxicity.

### STATEMENT REGARDING FEDERALLY SPONSORED RESEARCH OR DEVELOPMENT

The United States Government has rights in this invention pursuant to Contract No. DE-AC05-00OR22725 between the United States Department of Energy and UT-Battelle, LLC.

### FIELD OF THE INVENTION

The present invention relates to learning systems and, more particularly, to a Multi-Intelligent System for Toxicogenomic Applications (MISTA).

### BACKGROUND

Chemical compounds consisting of various molecules are introduced into the market place for industrial and pharmaceutical use almost daily. In many cases, these molecules have unknown or undesirable biological effects which can be toxic to humans. Pharmaceutical companies and organizations that introduce these chemical compounds are interested in anticipating the toxicological effects of these molecules as early as possible in order to mitigate any adverse reactions. It is also of interest for these industries to identify molecules that produce desirable biological effects.

The United States Food and Drug Administration requires a variety of clinical studies be performed for pharmaceutical testing before a molecule may be distributed for medical purposes. Comprehensive laboratory testing has been one of the most direct approaches for meeting the challenging requirements for evaluating toxicity and assessing risks of diverse chemicals and materials. The toxicity of the molecule may also be analyzed in various clinical trials, including trials with human subjects.

Accurately assessing risk from novel chemicals against a broad spectrum of biological end points requires a depth of chemical, physicochemical, and toxicological data and interpretative expertise that is generally prohibitive to obtain through experimental approaches. Experimental approaches can cost millions of dollars (involving several thousand test animals) and take five or more years to complete. As a result, many chemicals or materials may not undergo the degree of testing needed to support accurate health risk assessments and informed decision making. Moreover, the laboratory experimental approach is often used only after identifying a candidate molecule as being potentially beneficial.

An alternative approach is to perform in silico simulations configured to generate predictions about the properties of a molecule. The term “in silico” is used to reference simulations performed using computer software applications that model a real-world behavior of the molecule. The simulation may be based on the physical characteristics of the molecule and the characteristics of the simulated environment. As an example, an in silico simulation may be used to simulate the interaction between a molecule and a protein target. The output of the simulation may include a prediction regarding a biological effect or property of the molecule. For example, the output may predict the binding affinity of the molecule against the protein target. Models have been developed that can predict these kinds of low-level properties with a reasonable degree of accuracy. However, the accuracy of in silico simulations used to predict high-level effects have typically been low. Thus, even though some molecule interaction may be known to be related to an observed high-level effect, the in silico simulations are generally unable to predict whether a molecule is likely to have a given a high-level toxicological effect when introduced into a biological system (e.g., a human individual).

Over two decades ago, the National Research Council noted that toxicity data suitable for conducting health-hazard assessments were unavailable for almost 80% of the chemicals in general commerce, and adequate test data existed for only 10% of the substances. In 1994, the Government Accounting Office reported that the Environmental Protection Agency (EPA) had fully reviewed only about 2% of the existing chemicals in commerce. There are now well over 14 million known compounds, with thousands of new ones being developed each year. Given the number of uncharacterized compounds, the production rate of new ones, and the cost of testing, conventional techniques using laboratory-based approaches may not adequately provide the health-care and risk assessments needed for evaluating toxicological effects of chemical compounds and corresponding molecules.

Accordingly, there remains a need for improved techniques for predicting the toxicological effects of molecules in general, and for modeling biological effects that may result from the interaction between a test molecule and a biological system

### SUMMARY

A Multi-Intelligent System for Toxicogenomic Applications (MISTA) is provided. MISTA is an in silico toxicity-prediction platform based on neural networks and wavelets. MISTA can provide a rapid, accurate, and low-cost mechanism to predict, for example, the toxicity of drugs, chemicals, and environmental agents. One aspect of the invention is a dynamic database with links to other knowledge databases, including, for example, genomics, proteomics, metabolomics, metabonomics, liver toxicity, pathology and chemistry databases. MISTA can predict toxicity of molecules and chemical compounds using wavelet analysis and computational neural networks (CNNs) linked to modern computational chemistry to assess human health impacts from pharmaceuticals and chemicals. MISTA can provide high accuracy and flexibility in predicting diverse biological endpoints, including metabolic processes, mode of action, hepatotoxicity, and neurotoxicity. MISTA can also be used for automatic processing of microarray data to predict modes of action.

According to one embodiment, MISTA uses computational modules that are based on quantitative structure activity relationships (QSARs). The computational modules perform specific tasks and can communicate with other computational modules. The QSARs relate physicochemical characteristics to biological activities of chemical compounds through a mathematical function learned by the CNNs. According to one embodiment, MISTA employs wavelet analysis to optimize a representation of geometric and electronic molecular structures to determine relevant variables that satisfactorily characterize dependencies between molecular activity and structure. MISTA can calculate the chemical characteristics of each model, such as molecular structure to determine equations that correlate with molecular activity. MISTA can determine structural molecular features influencing activity, information that is important for determining a model equation that might be useful for predicting, for example, new pharmaceutical chemicals that are helpful for health care and that pose few risks.

### BRIEF DESCRIPTION OF THE DRAWINGS

A better understanding of the present invention and the features and benefits thereof will be accomplished upon review of the following detailed description together with the accompanying drawings, in which:

FIG. 1 illustrates an exemplary computing environment in accordance with an embodiment of the inventive arrangements;

FIG. 2 depicts an exemplary block diagram illustrating a training of a neural network model in accordance with an embodiment of the inventive arrangements.

FIG. 3 depicts an exemplary block diagram illustrating a testing of a neural network model in accordance with an embodiment of the inventive arrangements;

FIG. 4 depicts an exemplary method operating in the computing environment in accordance with an embodiment of the inventive arrangements;

FIG. 5 depicts a feature vector in accordance with an embodiment of the inventive arrangements;

FIG. 6 depicts a method for determining a topological representation in accordance with an embodiment of the inventive arrangements;

FIG. 7 depicts a method for generating a geometric representation and a topological representation in accordance with an embodiment of the inventive arrangements;

FIG. 8 depicts a method for evaluating prediction accuracy in accordance with an embodiment of the inventive arrangements;

FIG. 9 depicts a prediction plot for metabolic half-life in accordance with an embodiment of the inventive arrangements;

FIG. 10 depicts a prediction plot for metabolic rates in accordance with an embodiment of the inventive arrangements;

FIG. 11 depicts a prediction plot for blood brain barrier penetration in accordance with an embodiment of the inventive arrangements;

FIG. 12 depicts a prediction plot for blood brain barrier penetration using an aromaticity in accordance with an embodiment of the inventive arrangements;

FIG. 13 depicts a prediction plot for blood brain barrier penetration using an wavelet analysis in accordance with an embodiment of the inventive arrangements;

FIG. 14 depicts a prediction plot for partitioning of molecules across a blood brain barrier in accordance with an embodiment of the inventive arrangements;

FIG. 15 depicts a table for predicted and measured modes of action in accordance with an embodiment of the inventive arrangements;

FIG. 16 depicts a table for predicted and measured gene expressions in accordance with an embodiment of the inventive arrangements; and

FIG. 17 depicts a table for gene expressions profiles in accordance with an embodiment of the inventive arrangements.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

In a first embodiment of the present invention, a Multi-Intelligent System for Toxicogenomic Applications (MISTA) suitable for use to assess human health impacts from pharmaceuticals and chemicals is provided. The Multi-Intelligent System can include a database management module to access Two-Dimensional (2-D) connectivity tables of molecules, a molecular mechanics module to generate from the 2-D connectivity tables a feature vector comprising both a geometric representation and a topological representation of the molecules, and a computational neural network (CNN) to correlate the geometric wavelet features and topological features of the feature vector with biological endpoints to predict toxicological properties of the molecules. The molecular mechanics module applies a molecular transform and a wavelet transform to the geometric representation to produce geometric wavelet features. The topological connectivity indices describe electronic structural characteristics of the molecules. MISTA can also processes microarray data to predict gene expression activities for genes exposed to chemical compounds comprising the molecules.

In a second embodiment of the present disclosure, a computer-readable storage medium to model biological effects of molecules is provided. The storage medium can include computer instructions to generate a 3-D molecular structure of a molecule from Two-Dimensional (2-D) connectivity tables, transform the 3-D molecular structure to produce a geometrical representation of the molecule by applying a molecular transform and a wavelet transform to the 3D molecular structure, compute bond connectivity and electronic structure characteristics of the molecules to produce a topological representation of the molecule, generate a feature vector comprising the geometrical representation and the topological representation, and correlate the feature vector with biological endpoints for predicting toxicological properties of the molecules.

In a third embodiment of the present disclosure, a method for predicting toxicological effects of molecules is provided. The method can include obtaining a three-dimensional (3-D) structure of a molecule from a database, transforming the 3-D structure to a one-dimensional (1-D) geometrical representation using a combination of a molecular transform and wavelet transform, computing a topology and electronic structure of the molecule via topological indices, and generating a feature vector comprising the 1-D geometrical representation, the topology, and the electronic structure of the molecule.

Briefly, a toxic effect can be defined as any adverse effect of a chemical on a target organism or cell. A large battery of studies is generally needed to assess potential toxicity, including tests of absorption, distribution, metabolism, and excretion. There are many experimental variables to consider including the nature of the adverse health effects, animals used for the study, dose, and route of exposure. Such studies are also biochemically complex, because adverse effects are mediated by different mechanisms and metabolic pathways. A toxic substance may directly affect the target site, undergo transformation into an active metabolite, or trigger the activation of some other biological receptor. Biochemical and molecular toxicology deal with events that occur at the molecular level when toxic compounds interact with processes occurring in living organisms. Defining these interactions is fundamental to our understanding of toxicity, both acute (i.e., LD50) and chronic (e.g., carcinomas, cataracts, peptic ulcers, and reproductive effects). This knowledge is essential for identifying toxic hazards and for developing new therapies.

It is important, therefore, to define computational modules at multiple levels of toxicity on the basis of responses at the cellular, metabolic, target-organ, and systemic levels. Initial responses to chemical toxicity occur at the receptor and cellular levels, and methods that allow an accurate prediction of this response are crucial in the development of an integrated toxicity evaluation and predictive system.

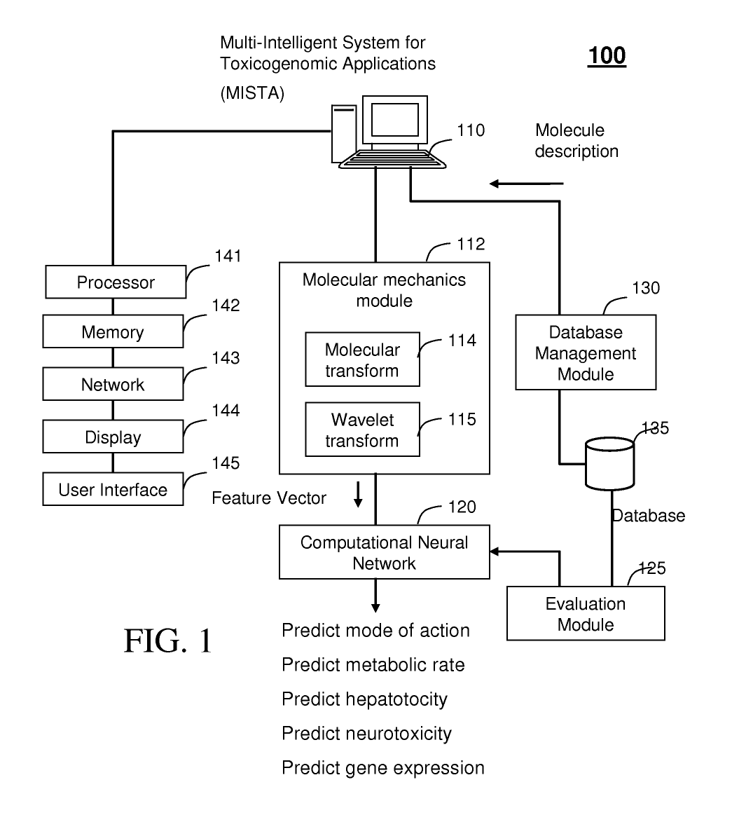

FIG. 1 illustrates MISTA 100 according to one embodiment suitable for use to assess human health impacts of pharmaceuticals and chemicals. MISTA 100 is a robust computational synthesis and toxicity assessment and evaluation system that predicts potential health risks resulting from exposure to new chemicals, materials, and mixtures, or chemical byproducts due to reactions or metabolic processes, interactions with other chemicals, molecular aging, or biodegradation. MISTA 100 is capable of predicting chemical toxicity on diverse data, including toxicogenomic and proteomic data, and includes automatic structural characterization of chemicals, accurate chemical similarity recognition, integration of multimedia data from internal and external sources, accurate estimation of toxicity, and estimation of confidence levels for predictions.

The computing environment of MISTA 100 can include a first computer system 110 and a database management module 130 communicatively coupled to a database 135 containing a plurality of molecule descriptions. As an example, the database management module 130 can collect and integrate chemical, physiochemical, and toxicological data, associated with molecule descriptions from the database 135 or other databases and on-line sources. The first computer system 110 can include a processor 141, a memory 142, a network component 143, a display 144, and user interface (e.g. keyboard and/or mouse) or any other suitable data processing component or network equipment. The processor 135 can obtain computer instructions and data via a bus (not shown) from the memory 142, and can be adapted to support the procedures for assessing human health impacts from pharmaceuticals and chemicals described herein. The memory 142 can hold the necessary programs and data structures, and can be one or a combination of memory devices, including Random Access Memory, nonvolatile or backup memory, programmable or Flash memories, read-only memories, or other suitable memory storage devices. In addition, memory 142 can be considered to include memory physically located elsewhere in a computer system 110, for example, any storage capacity used as virtual memory or stored on a mass storage device, direct access storage device, or on another computer 130 coupled to the computer system 110 via the network component 143. The computer system 110 may represent any type of computer, computer system or other programmable electronic device, including a client computer, a server computer, a portable computer, an embedded controller, a PC-based server, a parallel computer, or clustered computer system and other computers adapted to support embodiments of the disclosure.

MISTA 100 includes a molecular mechanics module 112 to generate a geometric and topological representation of molecules in the database 135, a computational neural network (CNN) 120 to predict potential health risks resulting from exposure to new chemicals, materials, mixtures comprising the molecules in the database 135 based on the geometric and topological representations, and an evaluation module 125 to validate toxicological predictions of the CNN 120. The molecular mechanics module 112 can apply a molecular transform and a wavelet transform to the geometric representation of the molecules to produce a feature vector that is provided as input to the CNN 120. The CNN 120 evaluates the geometric and topological features from the feature vector to predict at least one among metabolic processes, modes of action, hepatotoxicity, and neurotoxicity. The CNN 120 can also processes microarray data to predict gene expression activities for genes exposed to chemical compounds comprising the molecules. In one particular embodiment, the molecular mechanics module 112 combines wavelets for spatio-temporal multi-resolution analysis with the CNN 120 for predicting gene expression activity of microarray data.

Broadly stated, MISTA 100 is an integrated modular platform that supports an estimation of exposures for specific operational scenarios and an integration of exposure and toxicity data to predict scenario specific outcomes. MISTA 100 uses the CNN 120 coupled with spatio-analysis temporal capabilities of wavelets to predict neurotoxicity, carcinogenicity, mutagenecity, metabolic rates (e.g. in-vitro hydrolysis rates), hepatoxicity, and modes of action. With regard to hepatoxicity, MISTA can predict classifications of liver regions and types such as fatty liver, necrosis, cholestasis, fibrosis. With regard to neurotoxicity, MISTA 100 can predict whether structural transport properties of a molecule will penetrate a blood brain barrier.

MISTA 100 uses computational modules based on quantitative structure activity relationships (QSARs) that perform specific tasks, and can communicate “seamlessly” with other computational modules. More specifically, the molecular mechanics module 112 generates a QSAR representation providing a geometrical and topological representation of the molecules in the database 135, and the CNN 120 predicts toxicological effects of the molecules based on the QSAR representation. One premise of QSAR is that the biological activity of chemical compounds is a mathematical function of their physicochemical characteristics such as hydrophobicity, size, and electronic properties).

The general approach to QSAR analysis involves the calculation of a number of physico-chemical characteristics for each molecule in the database 135 and the application of statistical regression analyses to find the best equation(s) that correlate with a biological activity (e.g., anticarcinogenic effectiveness, ecotoxicological behavior, neuron receptor affinity, or toxicity). Structural features influencing activity can be used to generate molecular model equations that can be used to predict new candidate pharmaceuticals and commercial chemicals that will be useful for their intended purposes, while causing few or no adverse health effects to humans.

MISTA 100 incorporates machine learning techniques to develop models that learn from new data. This improves the CNNs 120 ability to perform a task as it analyzes more data related to the task. More specifically, the CNN 120 learns associations between QSAR representations of molecules and the toxicological effects of the corresponding molecules to generalize toxicological predictions of compound molecules or chemicals comprising the molecules. In general, the CNN 120 predicts an unknown attribute or quantity from known information. For example, the CNN 120 can predict the toxicological effects of a molecule against a specific protein target. Typically, the machine learning model of the CNN 120 is trained using a set of training examples. Each training example may include an example of an object along with a value for the otherwise unknown property of the object. For example, a QSAR representation of a molecule and a known toxicological effect for the molecule can be provided as a training example. By processing a set of training examples that includes both an object and a property value for the object, the model “learns” what attributes or characteristics of the object are associated with a particular property value. This learning” may then be used to predict the toxicological effects or to predict a classification for other objects.

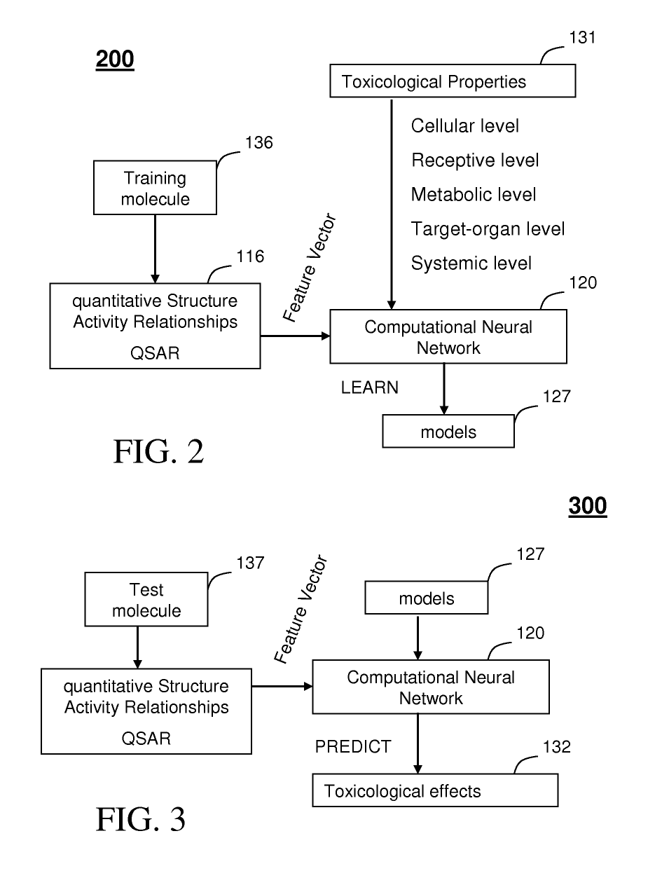

FIG. 2 depicts a block diagram that illustrates a procedure 200 for training the CNN 120 to associate QSAR representations of the molecules with toxicological effects of the molecules. Briefly, the molecular mechanics module 112 retrieves training molecules 136 from the database 135 (See FIG. 1) and generates a feature vector from a QSAR representation 116 of the molecule. The feature vector is provided as input to the CNN 120 along with corresponding toxicological properties 131 provided by the database management module 130. Toxicological properties can correspond to responsiveness to cellular levels, receptive levels, metabolic levels, target-organ levels, and systemic levels. During a training phase, the CNN 120 learns associations between the geometric and topological representations of the QSAR representation 116 and the toxicological properties 131. The CNN 120 generates models 127 for the molecules that identify the associations learned during the training. Upon completion of the training phase, the CNN 120 can access the models 127 to accurately predict toxicological effects of molecules exhibiting similar geometrical (e.g. structural arrangement) and topological (e.g. bond connectivity) features.

Moreover, the CNN 120 can generalize toxicological predictions on combinations of molecules based on the associations of the molecules learned during training. It should also be noted, that MISTA 100 can distribute the models 127 to other systems or networks in a modular arrangement. Furthermore, the database management module 130 can continually search for new molecules or molecular descriptors on-line or over a network. MISTA 100 can update, or retrain, the models 127 to incorporate the new molecules or molecular descriptors provided from the database management module 130 in a continued learning environment.

FIG. 3 is a block diagram that illustrates a procedure 300 for testing the CNN 120 on test (e.g. non-trained) molecules. Recall, the CNN 120 correlates the QSAR (e.g. structure-based) input and the biological endpoint (e.g. toxicological effect) during training to generate the models 127. Upon completion of training, during the testing, the CNN 120 accesses the models 127 used to predict toxicological effects 132 of unseen (e.g. test) molecules 137. The testing phase depicted by FIG. 3 is employed upon completion of training, and is a typical configuration for predicting toxicological effects 132 in practice. For example, the molecular mechanics module 112, responsive to a user request, retrieves a test molecule 137, or compound molecule, from the database 135 (See FIG. 1) and generates a feature vector from a QSAR representation of the test molecule. The feature vector is provided as input to the CNN 120 which uses the models 127 to predict the toxicological effects 132 of the test molecule 137.

In such regard, MISTA 100 provides a robust computational synthesis and toxicity assessment and evaluation platform that can provide the capacity needed to predict potential health risks resulting from exposure to new chemicals, materials, and mixtures; biological or chemical degradative processes (i.e., molecular aging and chemical reactivity processes); or metabolic byproducts. The computational approaches embodied by MISTA 100 allow for reasonably accurate predictions on the toxicological properties of chemical compounds. The machine learning method implemented by the CNN 120 is coupled with spatiotemporal analysis capabilities of wavelets to provide reasonably accurate predictions of metabolic processes, mode of action, and hepato- and neurotoxicity, and for automatic processing of microarray data for predicting modes of action.

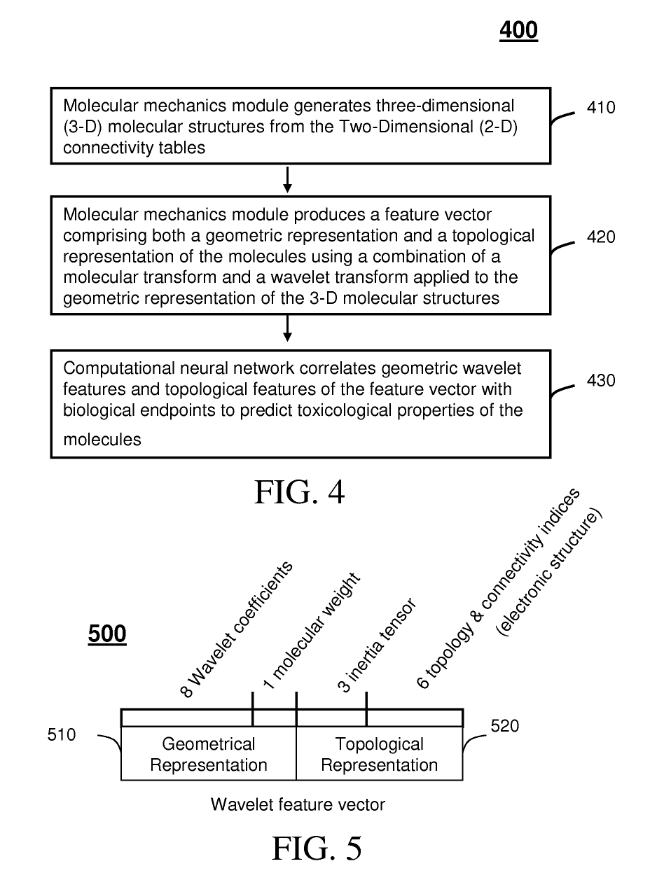

Referring to FIG. 4, a method 400 for predicting toxicological effects of molecules in accordance with one embodiment implemented by (same problem: don't talk about 100 unless you mention first reference jointly to FIG. 1; perhaps move the reference to FIG. 1 in the sentence after the next up here) MISTA 100 is shown. More specifically, the method 400 teaches how to produce a QSAR feature vector from molecule descriptors in the database 135 and use the feature vector to predict toxicological effects. Reference will be made to FIG. 1 when describing the method although it is understood that the method 400 can be implemented in any other suitable device or system using other suitable components. Moreover, the method 400 is not limited to the order of the steps as illustratived, but it will be readily apparent that the steps of the procedure can occur in different sequences. In addition, the method 400 can contain a greater or a fewer number of states than those shown in FIG. 4. (Same)

At step 410, the molecular mechanics module 112 can generate a three-dimensional (3-D) molecular structure from Two-Dimensional (2-D) connectivity tables of the molecules stored in the database 135. MISTA 100 includes the database management module 130 to access Two-Dimensional (2-D) connectivity tables of molecules from the databases 135. The database management module 130 contains links to knowledge databases such as genomics, proteomics, metabolomics, metabonomics, liver toxicity, pathology and chemistry databases. Notably, MISTA 100 operates in an open program environment and is capable of incorporating and using new data and data banks containing various molecules as they become available. This allows MISTA 100 to utilize multiple, independent toxicology prediction techniques in parallel, enabling it to obtain integrated predictions with greater accuracy and confidence than could be obtained by a single technique.

The representation of molecular structures influences the level of insight that can be gained from chemical information. In the past, chemical structures were largely represented by fragment codes and line notations. For example, a Wiswesser line notation allows a highly concise coding of chemical structures but is insufficient for representing chemical reactions in which individual bonds are broken and made. This deficiency led to the development of connection tables, a method that has gained universal (necessary adjective? Remember: if you're in court, your opponent may say prove it was universally accepted or else admit you mislead the Patent Office) acceptance. Connection tables use a unique and unambiguous coding of a chemical structure by canonical numbering of the atoms in the molecule. Connection tables show that molecules consist of atoms and bonds, basically providing a valence-bond representation of the molecule. Although this representation has the advantage of requiring a minimal set of numbers, it provides only two-dimensional (2-D) information.

The molecular mechanics module 112 performs an in-depth analysis of chemical information, particularly an analysis of relationships between structure and physical, chemical, or biological properties, to generate a molecular representation (e.g. 3-D structure), since the connection tables are generally inadequate for representing 3-D structures. Biological activity is intimately tied to the 3-D molecular structure and to electronic properties of specific molecular sites. The molecular mechanics module 112 develops molecular descriptors that encode the full 3-D structural information from the 2-D connection tables. The structural information of the 2-D connection tables has been determined using X-ray analysis for more than 100,000 organic compounds and is available in the Cambridge Crystallographic Database.

The molecular mechanics module 112 performs real-time computations of 3-D structures based on information contained in connection tables of the database 135. The molecular mechanics module 112 employs molecular mechanics codes that employ highly efficient quasi-Newton Raphson techniques combined with a unique geometric statement function technique to optimize the first and second derivatives to perform the minimization of a “universal” potential energy function. The codes are further supplemented with simulated annealing and other Newton methods. The molecular mechanics module 112 can be supplemented with other modules such as CONCORD,10 ALCOGEN,11 CHEM-X12, MOLGEO,13 COBRA,14 CORINA,15 and CONVERTER, to convert data from 2-D connection tables to 3-D molecular structures.

At step 420, the molecular mechanics module 112 produces a feature vector comprising both a geometric representation and a topological representation of the molecules. Briefly, FIG. 5 depicts an exemplary feature vector 500 comprising a geometric representation 510 and a topological representation 520. The feature vector 500 can identify wavelet coefficients, a molecular weight, inertia tensor, topology and connectivity indices as will be explained ahead. The geometric representation is produced from the 3-D molecular structures using a combination of a molecular transform and a wavelet transform. The topological representation describes the connectivity and the electronic properties of the molecule.

The molecular mechanics module 112 converts the 3-D molecular structure representation to a vector or matrix notation. One approach implemented by the molecular mechanics module 112 uses the Cartesian or internal coordinates of the individual atoms of the molecule. Since each atom requires three coordinates, the size of the descriptor will reflect the number of atoms contained in the molecule (3N numbers). The molecular mechanics module 112 uses methods to make correlations between structure and activity that require each molecule of a data set to be represented by the same number of variables. The molecular mechanics module 112 applies a molecular transform 114 to convert the 3-D molecular structure representation of the molecules to a feature vector 500. The molecular transform 114 applies an efficient equation, in which the 3N data is converted into S, where S is a resolution control and can be taken as any number. In one arrangement, S=32 is sufficient to distinguish most compounds, though S can be more or less than 32. The number of features in the feature vector 500 is equal to S (e.g. 32 features),and provides reasonably accurate descriptions of the molecule.

A secondary approach, used singly or in combination with the molecular transform 114, and implemented by the molecular mechanics module 112, converts the full 3N values for the structure into N values using a wavelet transform 115. More specifically, the molecular mechanics module 112 applies a wavelet transform to the geometric representation produced by the molecular transform 114 to produce geometric wavelet features. The wavelet transform 115 provides simultaneous localization in time and frequency domains. Wavelets are mathematical functions that divide data into different frequency components. Each wavelet can have a basis component with a resolution matched to its scale (analysis according to scale). The molecular mechanics module 112 uses a wavelet prototype function, called the mother wavelet for analysis of the 3-D molecular structure representation. Temporal analysis is performed with a contracted, high-frequency version of the prototype wavelet, and frequency analysis is performed with a dilated, low frequency version of the same wavelet. Because the original signal or function can be represented in terms of a wavelet expansion, the molecular mechanics module 112 can perform data operations using just the corresponding wavelet coefficients. The molecular mechanics module 112 can then truncate the wavelets coefficients below a threshold to give a sparse representation of the 3-D molecular structure.

The wavelet transform 114 also reduces the length of the feature vector 500 used to describe the 3-D molecular structure of the various molecular compounds. In one embodiment, the molecular mechanics module 112 employs a discrete wavelet transform with a four-coefficient Daubechies mother wavelet to reduce the number of features in the feature vector 500. As an example, the wavelet transform 115 can reduce the feature vector 500 generated by the molecular transform 114 from S=32 features to S=8 features. As an example, referring to FIG. 5, eight geometric wavelet features (e.g. wavelet coefficients) are shown in the feature vector 500 of the geometrical representation 510. The wavelet transform efficiently compresses and de-noises data by eliminating small (thresholding) coefficients. In such regard, the molecular mechanics module 112 produces a 1-D vector that can be inverse-wavelet-transformed back to the original data set with good accuracy. The 1-D feature vector 500 can be directly supplied as input to the CNN 120 to yield a prediction accuracy similar to the non-transformed data; that is, a 3-D molecular structure representation in Cartesian coordinate form. Notably, the wavelet transform 115 extracts those features of the 3-D molecular structure that are most representative of the salient structural features of the molecules. The wavelet transform 115 also provides significant data compression for storing the structural features of the molecules.

At step 430, the CNN 120 correlates the geometric wavelet features and topological features of the feature vector 500 with biological endpoints to predict toxicological properties of the molecules. Notably, the feature vector 500 contains geometric wavelet features that identify a molecular structure representation of the molecules and topological connectivity indices that describe electronic structural characteristics of the molecules. As previously noted, and as shown in FIG. 5, the feature vector 500 comprises both geometric representations 510 (discussed above) and topological representations 520.

The spatial arrangement of atoms constituting a molecule is specified by its topology and geometry. Topology reflects the pattern of interconnections between atoms and often is expressed in the form of connectivity tables. Topology can also describe the electronic properties of the molecules. Geometry encompasses the values of the coordinates of the atoms (as discussed above). Both the topology and geometry of a system provide important, complementary types of information. The mathematical discipline of topology examines the interconnections of components but does not consider the detailed coordinates of compounds. Graph theory, a sub-discipline of topology, is used to study the chemical physics of molecular systems. Applications of graph theory generate connectivity indices, which are appealing because each index can be calculated exactly from valence-bond diagrams. The invention utilizes at least four fundamental topological indices that Applicants have determined to adequately specify the bond connectivity and important electronic structure characteristics associated with the topology. Two atomic indices are needed to compute topological indices.

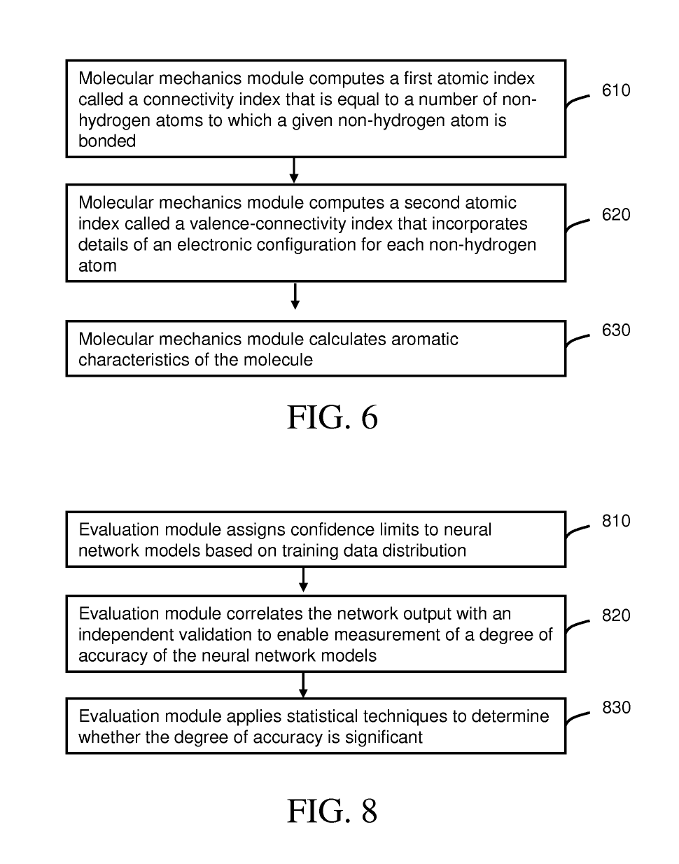

FIG. 6 describes method steps for producing the topological representation 520 of the feature vector 500. Referring to FIG. 6, at step 610 the molecular mechanics module 112 computes a first atomic index called a connectivity index that is equal to a number of non-hydrogen atoms to which a given non-hydrogen atom is bonded. At step 620, the Molecular mechanics module computes a second atomic index called a valence-connectivity index that incorporates details of an electronic configuration for each non-hydrogen atom. These two atomic indices enable the computation of the zero-, first-, second-, and higher-order (a finite number) connectivity indices. Electronic properties of the molecule can also be modeled by a molecule's aromaticity. Aromaticity characteristics of a molecule can also affect its activity. As shown in step 630, the molecular mechanics module 112 estimates the aromaticity of the molecules. One measure implemented by the molecular mechanics module 112 is a harmonic-oscillator model of aromaticity (HOMA). This model compares the bond lengths in the molecule to an optimal bond length, Rₒₚₜ. The equation for calculating the HOMA index is

$$HOMA \qquad 1 \qquad \frac{ }{N} {\sum }_{i = 1}^{N} {( \begin{matrix}{R}_{opt} & {R}_{i}\end{matrix} )}^{2}$$

where is a constant chosen so that HOMA=0 for the Kekule' structures of the aromatic systems and HOMA=1 for systems with all bond lengths equal to Rₒₚₜ, N is the number of bonds, and Rᵢ is the individual bond length. The molecular mechanics module 112 can decompose the HOMA model further into a bond elongation term, EN, and a bond length alternation term, GEO,

$$\begin{matrix}HOMA \begin{matrix} 1 & EN & GEO\end{matrix} & \\ EN \begin{matrix}f & {( \begin{matrix}{R}_{opt} & {R}_{av}\end{matrix} )}^{2}\end{matrix} & \\ \int \{ \begin{matrix}1 : {R}_{av} & {R}_{opt} \\ 1 : {R}_{av} & {R}_{opt}\end{matrix} & \\ GEO \frac{ }{N} {\sum }_{i = 1}^{N} {( \begin{matrix}{R}_{opt} & {R}_{av}\end{matrix} )}^{2} & \\ R ( n ) \begin{matrix}R ( 1 ) & c ln ( n )\end{matrix} & \end{matrix}$$

The constant, c, can be estimated using the typical values for single, R(1), and double, R(2), bonds

c exp{[R(1) R(2)]/ln(2)}

The molecular mechanics module 112 can then calculate the bond order for the individual bonds by

n exp{[R(1) R(n)]/c}

Each bond can be converted into a “virtual” C—C bond using

R(n)=1.467−0.1702 ln(n)

The molecular mechanics module 112 implements these equations to calculate an estimate of the degree of aromaticity for a molecule.

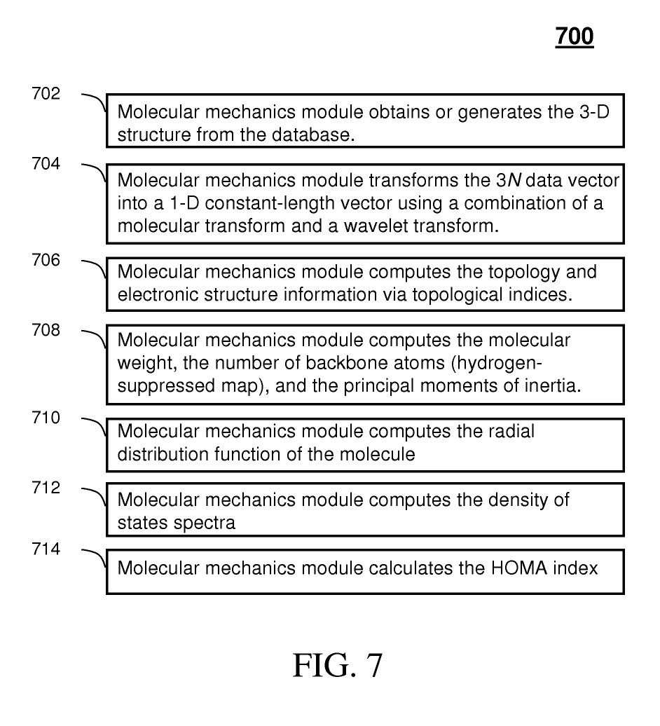

FIG. 7 presents a method 700 that summarizes the approach described above for generating the geometrical representation 510 and topological representation 520 of the feature vector 500 to describe molecules for input to the CNN 120. The method 700 can be practiced with more or less than those steps shown and is not limited to the order of the steps shown. Briefly, at step 702, the molecular mechanics module obtains or generates the 3-D structure from the database. At step 704, the molecular mechanics module 112 transforms the 3N data vector into a 1-D constant-length vector using a combination of a molecular transform and a wavelet transform. At step 706, molecular mechanics module 112 computes the topology and electronic structure information via topological indices. In addition to computing the topology and electronic structure information via topological indices (up to second order) and computing the aromaticity, the molecular mechanics module 112 at step 708 can compute the molecular weight, the number of backbone atoms (hydrogen-suppressed map), and the principal moments of inertia. The molecular mechanics module 112 can also compute a radial distribution function of the system as shown in step 710 (if it is a single molecule, this information will not be needed); this function is useful for liquids or polymeric materials. At step 712, the molecular mechanics module 112 can compute the density of states spectra (this is achieved by performing a normal-mode analysis). At step 714, the molecular mechanics module can compute the HOMA index as previously discussed.

The method 700 captures information about structural and electronic properties of the molecules, which in turn describe the molecular behavior in a biochemical environment. The full input feature vector using steps 702-714 encompasses approximately 30 features (e.g. variables). Eighteen (18) input features for the feature vector 500 can be used to predict both acute and chronic chemical toxicity.

For example, referring back to FIG. 5, it can be seen that the feature vector 500 uses the 18 features associated with steps 702-706 above. The 18 features include 8 features to describe the 3-D structure (wavelet threshold of 3-D Cartesian coordinates), 1 component for the molecular weight, 3 components for the inertia tensor, and 6 components for topology and connectivity (including electronic structure). Notably, the number of features for the geometrical representation 510 and the topological representation 520 may be more or less than the number shown in FIG. 7.

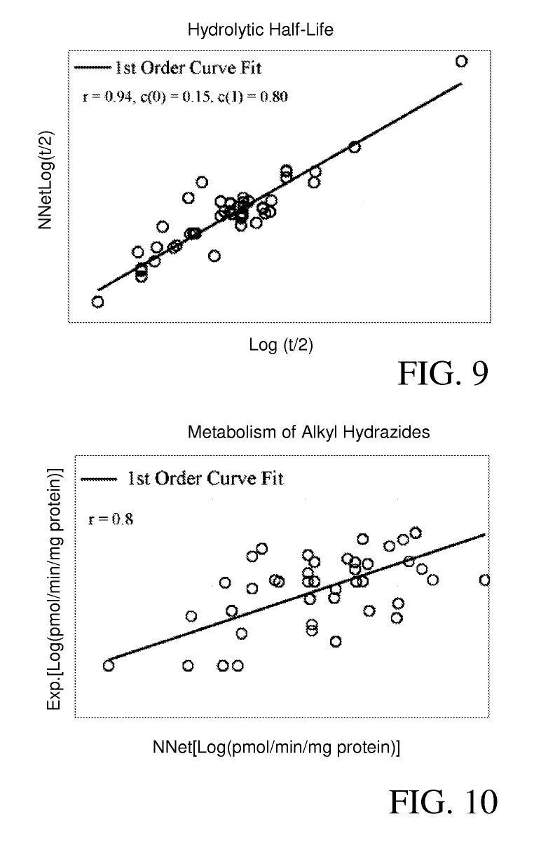

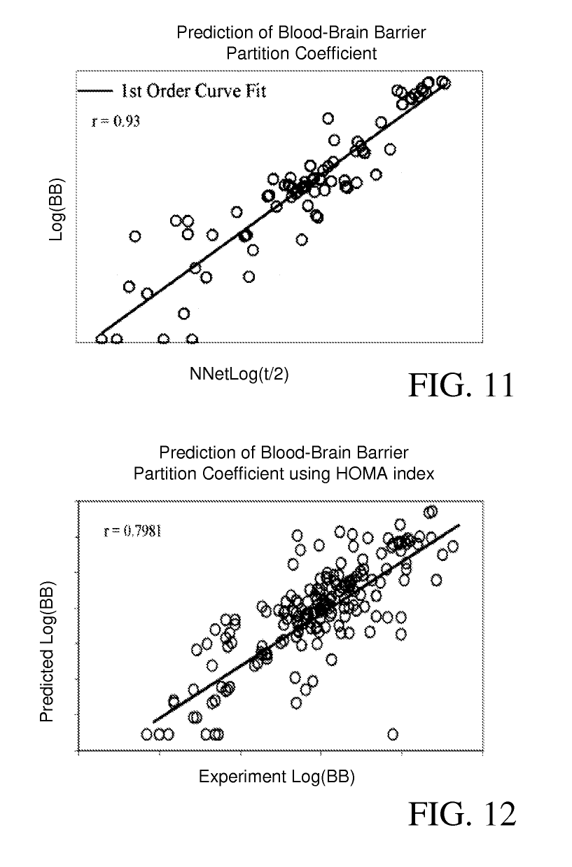

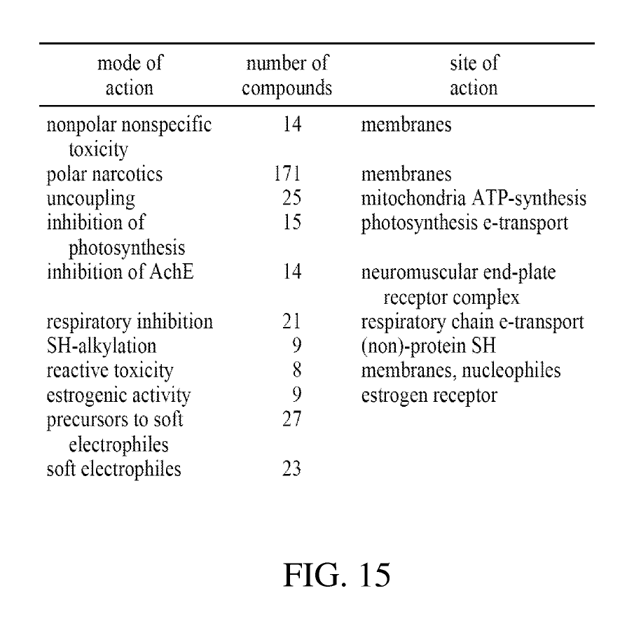

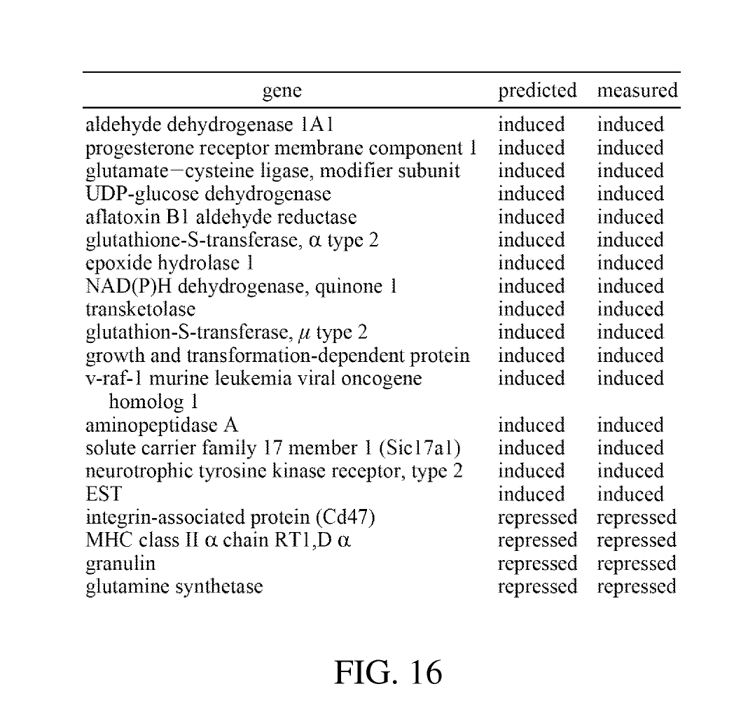

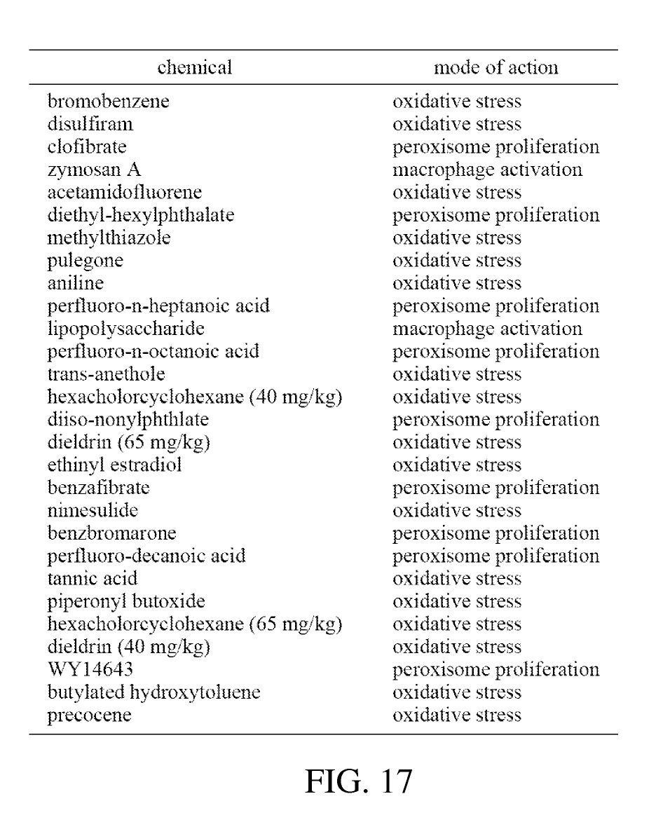

The 18 input features of the feature vector 500 shown in FIG. 5, represent a molecular Hamiltonian and provide accurate structure property predictions for the n-octanol/water partition coefficient (log P), acute inhalation toxicity, Carcinogenic Potency, carcinogenicity, mutagenicity, metabolic half-life in human blood (see FIG. 9), mode of action (see FIG. 15), glucagon receptor affinity, hepatotoxicity, partitioning of chemicals across the blood-brain barrier (see FIG. 11), gene expression profiles for hepatotoxins (see FIG. 16 and FIG. 17), and the NCI-60 human cancer cell lines. Including the HOMA index improves predictions for blood-brain barrier penetration. FIG. 15 presents ecotoxicologically relevant modes of action. FIG. 16 presents examples of some of the predicted and measured gene expression levels for Bromobenzene. FIG. 17 lists 28 hepatotoxins and their modes of action for microarray expressions measured for 66 genes.

FIG. 8 presents a method 800 for evaluating a prediction performance and degree of accuracy of the learned models. Referring to FIG. 8, at step 810, the evaluation module 125 assigns confidence limits to neural network models (i.e. models 127) based on training data distribution. At step 820, the evaluation module 125 correlates the network output with an independent validation to enable measurement of a degree of accuracy of the neural network models (i.e. learned models 127). At step 830, the evaluation module 125 applies statistical techniques to determine whether the degree of accuracy is significant. Standard statistical techniques can include t-statistic with percent confidence, variance, correlation coefficient, and mean values. As one example, the evaluation module 125 can plot the CNN output against the actual results to reveal a cluster of points around a straight line. The evaluation module 125 can estimate the slope of the line and the variance of the points in the cluster around the line to determine the significance of the prediction. The evaluation module 125 can also perform validation checks of the CNN prediction performance by comparing attributes or outcomes such as physical properties with values obtained from the literature or that can be calculated from computational chemistry. As one example, physical properties can correspond to fundamental thermodynamic properties of molecules. The evaluation module 125 can determine if the neural network module generates reasonably accurate predictions, and assign confidence intervals based on the accuracy for its prediction of a toxicological endpoint.

### EXAMPLES

The present invention is further illustrated by the following examples, which should not be construed as limiting the scope or content of the invention in any way. In the following, MISTA 100 prediction results for metabolic rates, modes of action, hepatotoxicity, neurotoxicity, and gene expressions are presented.

Prediction of Metabolic Rates: The prediction of metabolic processes such as the enzymatic hydrolysis of noncongener carboxylic esters has often challenged most standard QSAR methods. Carboxylic ester hydrolases efficiently catalyze the hydrolysis of a variety of ester-containing chemicals to their respective free acids. These enzymes exhibit broad and overlapping substrate specificity toward esters and amides, and the same substrate is often hydrolyzed by more than one enzyme. Consequently, their classification is difficult and somewhat confusing. Studies have shown that humans express carboxylesterase in the liver, plasma, small intestine, brain, stomach, colon, macrophages, and monocytes. In vitro hydrolytic half-lives measured in rat blood have been reported to be orders of magnitude lower than those measured in human blood for esmolol or remifentanil, but the opposite was found for flestolol. Thus, the extrapolation of animal results to humans is not always a good approach, and accurate structure-metabolism relationships are needed to predict the rate of enzymatic hydrolysis.

A total of 80 compounds belonging to seven different chemical classes were used in a study performed by the Athors. These include two short-acting beta-blocker series, short-acting angiotensinconverting enzyme inhibitors, opioid analgesics, soft corticosteroids, antiarrhythmic agents, and buprenorphine prodrugs. The input feature vector 500 to the CNN 120 consisted of the 18 variables described above, and the output was the hydrolytic half-life (log t½). The CNN 120 was able to accurately predict the in vitro hydrolysis rates of these chemicals in human blood (r) 0.94) as shown in FIG. 9. This structure-metabolism module was also tested on novel alkylidene hydrazides. In this case, the metabolic pathways were not necessarily known, but previous studies have shown a fast metabolic turnover that resulted in poor in vivo pharmacokinetic (PK) profiles; results, therefore, were based on an in vitro analysis of rat liver microsome incubations. The metabolism data ranged from 14 to 606 pmol/min/mg of protein.

Overall, the neural-network module was capable of predicting the metabolism rate in picamoles per minute milligram of protein to a reasonable accuracy (r) 0.8), as shown in FIG. 10, but not as well as that discussed for enzymatic hydrolysis in FIG. 9. The PK profiles had to be estimated from a liquid chromatography mass spectrometry analysis of incubations with rat liver microsomes. The combined results (FIG. 9 and FIG. 10) demonstrate predictions of the CNN 120 to metabolic processes of chemical compounds. These preliminary results are encouraging for the development of more extensive structure-metabolism evaluation and prediction tools, including those for the cytochrome P450 system, which is important in both prokaryotic and eukaryotic cells. This P450 system appears to interact with almost every kind of chemical bond, most often via oxidative mechanisms, but also by reduction, as is the case for prostaglandin synthetase cooxidation, flavin containing monooxygenase, and alcohol and aldehyde dehydrogenase.

Predicting Mode of Action: Assessing the likely mode of action for a toxic compound is critical for correctly predicting toxicity. Compounds having different modes of action are toxic in different ways due to different interactions at the biomolecular level, and their eco- and biotoxic effects in any given test system generally must be predicted with different QSARs. Modes of toxic action were predicted for 336 test compounds for up to 11 modes of action with 95% accuracy (see FIG. 15). Results for predicting the mode of action for chemical compounds on the basis of structural information (95% classification accuracy) exceed those previously reported in the literature, which generally range from 85 to 89% accuracy. This approach can be used to develop mode-of action classification capabilities with similar accuracies for a larger set of possible modes of action. Prediction results of MISTA 100 suggest that the fundamental structural input of chemical compounds representing the molecular Hamiltonian, as exemplified by the feature vector 500 is sufficient to formulate accurate correlations between structure and mode of action.

Predictive Hepatotoxicity: Some substances manifest significant toxicity only in certain tissues while nontarget tissues remain relatively unaffected. For example, the chemical paracetamol exhibits toxicity in the liver by necrosis, acrylamide causes toxicity in the nervous system by axonopathy, bleomycin causes damage to the respiratory system by pulmonary fibrosis, and chloroquine causes damage to the eye by retinopathy. These are complex phenomena involving several interacting processes that include the pharmacokinetics and distribution of the toxicant, the presence of specific uptake mechanisms in susceptible tissues, the specific biochemistry of the target tissue, including the presence of the activation or deactivation enzymes, and the ability of the tissues in question to repair a particular damage or lesion elicited by the toxicant.

The liver is often the main target for chemically induced toxicities, and several factors contribute to its particular susceptibility. The liver is the organ with the highest complement of P450 in terms of quantity as well as numbers of isozymes and is the organ in which P450 enzymes are most readily induced. It is also the site of metabolism for xenobiotics absorbed from the gastrointestinal tract, the major route of absorption for most xenobiotics. Additionally, the liver may activate chemicals that can then be transported to distant tissues to affect toxicity in those organs. The liver maintains normal sugar concentration in the blood by storing glycogen and releasing glucose and synthesizes many proteins and other vital components of blood plasma. Damage to the liver or interference with its vital functions can thus be extremely harmful or even lethal. Liver damage can be classified by the types of lesion, such as (1) fatty liver (lipid content greater than 5% by weight), (2) necrosis (chemical damage leading to cell death that can affect different areas of the organ), (3) cholestasis (obstruction to bile flow), (4) hepatitis (inflammation of liver tissue caused by diseases), (5) fibrosis (large amounts of collagen and other extracellular matrix proteins), (6) cirrhosis (chronic liver damage characterized by deposition of massive amounts of collagen), and (7) carcinogenesis (cancer of the liver)0.32

In another example, the invention was used to examine two data sets, for chemicals known to cause acute hepatic injury, typically hepatitis, or secondary toxic effects, such as elevated liver enzyme levels. Neural-network classification of these chemicals into acute or secondary liver toxicity was 100% accurate. The inclusion of chemicals that were not hepatotoxins did not reduce the accuracy.

Additional studies applying the invention were carried out to investigate a broader range of general predictive capabilities. In this case, results were predicted for the lesion types: fat, necrosis, cirrhosis, carcinoma, and/or cholestasis, known to be caused by ˜100 various organic hepatotoxicants that have been experimentally studied. Classification to the type of lesion was 97% accurate for necrosis, 96% accurate for fatty liver, 98% accurate for cirrhosis, 94% accurate for carcinoma, and 98% accurate for cholestasis.

Predicting Neurotoxicity: The nervous system is extremely complex, and toxins can act at many different points. It has three basic functions: to detect and relay sensory information inside and outside the body, to direct motor functions of the body, and to integrate the thought processes of learning and memory. The nervous system consists of two fundamental anatomical divisions, the central nervous system (CNS) and the peripheral nervous system (PNS). The CNS includes the brain and the spinal cord and serves as the control center. It processes and analyzes information received from sensory receptors and, in response, issues motor commands to control body functions. The PNS consists of all nervous tissue outside the CNS and contains two forms of nerves: afferent nerves, which relay sensory information to the CNS, and efferent nerves, which relay motor commands from the CNS to various muscles and glands.

The human brain is one of the most complicated systems known. It contains an estimated 100 billion neurons, each forming as many as 100,000 synapses leading to a system with up to 10¹⁶ connections having an astronomically large number of possible different connections estimated to be larger than the number of atoms in the universe. The brain also exhibits enormous diversity with perhaps as many as 1,000 different cell types, each with a highly intricate and specific communication pathway. To understand such a special organ and the myriad events that occur within its vast network of cellular interconnections requires the application of a very broad range of scientific disciplines. The union of disciplines that emerged in the past three decades to understand higher brain functions such as perception, learning, and memory is now known as the neurosciences.

The nervous system is quite vulnerable to toxins since xenobiotic chemicals interacting with neurons can alter critical voltages and concentrations of ions required for signal transduction and transmission continuance. Most of the CNS, however, is protected by an anatomic barrier between the neurons and blood vessels called the blood-brain barrier (BBB). The BBB is composed of unique tight junctions of the brain capillary endothelial cells resulting from tissue specific gene expression. These tight junctions, which exhibit electrical resistance as high as 8000 Ohm-cm², eliminate a paracellular pathway of solute movement through the BBB. The virtual absence of pinocytosis across brain capillary endothelium eliminates transcellular bulk flow of a circulating solute through the BBB.

The BBB is actually composed of two adjacent membranes in brain capillary endothelial cells. The lumenal and the ablumenal membranes are separated by approximately 300 nm of endothelial cytoplasm enriched with mitochondria (some 4 times more than other capillary cells), resulting in the increased metabolic capacity that accounts for the rapid degradative processes of endogenous and exogenous agents. Additionally, there are numerous active efflux systems and enzymes for the transport and inactivation of agents. Passage through the BBB therefore requires penetration of two membrane barriers plus diffusion across 300 nm of cytoplasm full of enzymes and active efflux systems. In addition to these barriers, the BBB has a basement membrane that appears to be expressed from another type of BBB cell called the pericyte, which also expresses a number of ectoenzymes.

Another type of BBB cell structure, the astrocyte foot processes, compose 99% of the BBB on the ablumenal side (separated by 20 nm that is filled by the basement membrane) and express p glycoproteins. These p-glycoproteins cause an ATP-dependent active efflux of drugs from the cellular compartment to the extracellular space. Therefore, pericyte ectoenzymes, astrocyte foot process p-glycoproteins, and endothelial active efflux systems at the endothelial ablumenal membrane, together with the three different membrane barriers (i.e., lumenal, ablumenal, and basement), work together to prevent brain uptake of xenobiotics. Solutes can gain access to brain interstitium via one of two pathways: lipid-mediated (generally limited to small molecular weight and lipid-soluble compounds, although local hydrophobicity, flexibility, and number of accepted or donated hydrogen bonds also play a role) or catalyzed transport (carrier mediated or receptor-mediated processes). This elaborate series of obstacles protects the brain from a barrage of bacterial, viral, and other chemical assaults that would lead to severe or even lethal consequences. The same barrier that protects us, however, also inhibits the development of therapeutics that can treat CNS disorders. Virtually all smallmolecule drugs generated by receptor-based, high-throughput drug screening programs cannot cross the BBB.

Toxic damage to the nervous system can occur at peripheral sensory receptors and sensory neurons, which affect blood and intraocular pressure, temperature, vision, hearing, taste, smell, touch, and pain. Examples of compounds that can cause damage in these areas are heavy metals (in particular, lead and mercury), several inorganic salts, and organophosphorus compounds. Another site where potential damage can occur is at motor neurons; damage to these by compounds such as isonicotinic hydrazide can cause muscular weakness and paralysis. Low levels of inorganic mercury and carbon monoxide can cause interneuronal damage and lead to significant learning deficiencies, loss of memory, loss of coordination, and emotional disorders. In general, toxic damage to the nervous system occurs by one of the following basic mechanisms: direct damage and death of neurons and glial cells, interference with neural-electrical transmission, or interference with neural-chemical transmission.

Since poor penetration of a compound means low bioavailability, much effort has been devoted to developing accurate methods for predicting BBB partitioning of chemicals. Structure-transport properties as pertaining to BBB partitioning of chemical compounds were included for training the CNN 120 to predict neurotoxicity. A data set consisting of 106 compounds was used to test our neural network module. Toxicocological effects of the compounds in the data set have been studied and documented in laboratory tests. The compounds ranged from small organics to large drugs such as indinavir and verapamil, having in vivo measured BBB partition coefficients (log BB) in rats (ratio of the concentration of the compound in the brain to that in the blood). The BBB partitioning data span a range of more than 3 orders of magnitude. While partitioning of chemicals across the BBB is thought to be strongly dependent on local hydrophobicity, molecular size, lipophilicity, and molecular flexibility, nearly all previous attempts to delineate an accurate relationship have had little success. Correlations with r) 0.90 appear to be among the best results reported in the literature. Our results, shown in FIG. 11, demonstrate the generality and accuracy of our approach to toxicological predictions; a linear correlation coefficient for the data set of r) 0.93 was obtained. One can expect this accuracy to apply over a broad range of compounds that span the trained neural network domain: log(BB) from −2.15 to 1.44.

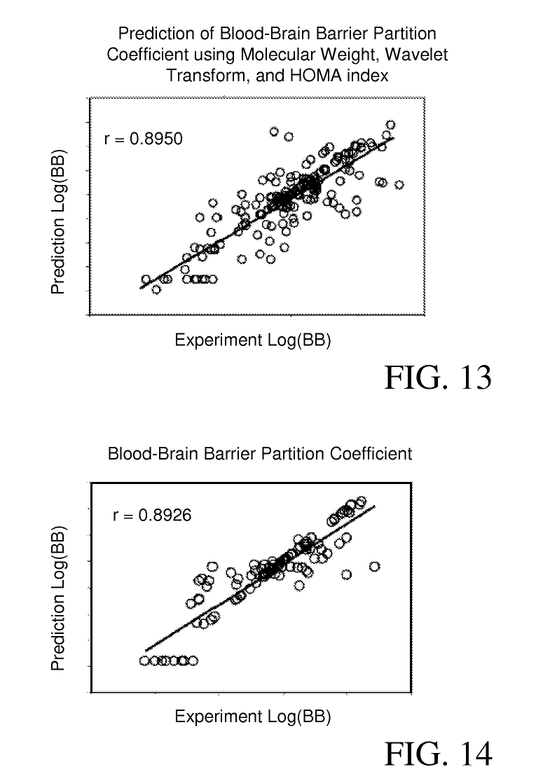

The HOMA index was added into the above QSAR model in an attempt to improve the overall correlation. Various combinations of the structural components discussed above were generated from the QSAR model and input into the CNN 120. The CNN 120 was used to predict the blood brain partition coefficient for a larger and more diverse data set which consisted of 193 molecules. The data set was compiled from three different studies and included molecules ranging from small alcohols and ethers to larger molecules such as ranitidine and nevirapine. The results of using different input variables are shown in FIG. 12 and FIG. 13. Including the HOMA index in the input variables increases the linear correlation coefficient from r) 0.7856 to r) 0.7981. The best correlation, r) 0.8590, was found when the molecular weight, wavelet transform, and HOMA index were used as the input variables, shown in FIG. 13. While this combination works well for this particular data set, it may not be sufficient for predicting toxicity or for different sets of molecules. A sensitivity analysis performed independently of the data set will allow rapid and optimal selection of the input variables.

Another data set of BBB partition coefficients 34 was also used to test the predictability of the neural network. The results, using all 19 input variables, are shown in FIG. 14. Omitting the HOMA index decreases the correlation coefficient from r) 0.8926 to r) 0.8771. Using the three components that gave the best correlation in the previous data set did not improve the results for this set.

Gene Expression Microarray Analysis: MISTA can be applied directly to microarray data by using a combination of wavelets for spatio-temporal multiresolution analysis, noise and trend reduction, and compression with neural networks to yield reasonably accurate predictions of gene expression activities. For example, FIG. 16 shows a sample (only those of bromobenzene are shown) of the 1,848 total examples of the predicted induced, repressed, or unchanged levels of expression for 66 genes resulting from exposure to the 28 different hepatotoxins shown in FIG. 17. The CNN 120 correctly predicted gene expression levels for all but two cases (clofibrate and hexachlorocyclohexane at a 65 mg/kg dose), giving 93% accuracy. These particular results were obtained from direct prediction based on chemical structure instead of DNA microarray data. The inverse problem, using the microarray data as input into a neural network and predicting the mode of toxic action, gave 100% accuracy. Thus, predictions of the effects of chemical compounds can be made with considerable confidence by using two simultaneous predictive modules, one based on structure-toxicity modules and the other based on the analysis of microarray data. Data corresponding to the −60 cancer cell lines with drug treatments were also evaluated. Gene expression levels were expressed as log(red/green), and ratios of fluorescence measurement were corrected by computational balancing of the two channels. The data set includes expression values for 1376 genes plus 40 assessed molecular targets for the drugs (1416 clones), in the 60 different cell lines corresponding to nine different types of cancer. The gene expression data is used as input to a neural-network system trained to predict the mode of action for the set of drugs.

As required, detailed embodiments of the present method and system have been disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” or “processor” can be defined as any number of suitable processors, controllers, units, or the like that are capable of carrying out a pre-programmed or programmed set of instructions. The terms “program,” “software application,” and the like as used herein, are defined as a sequence of instructions designed for execution on a computer system. A program, computer program, or software application may include a subroutine, a function, a procedure, an object method, an object implementation, an executable application, a source code, an object code, a shared library/dynamic load library and/or other sequence of instructions designed for execution on a computer system.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications, permutations and variations as fall within the scope of the appended claims. While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A Multi-Intelligent System for Toxicogenomic Applications (MISTA) suitable for use to assess human health impacts from pharmaceuticals and chemicals, comprising:
a database management module to access Two-Dimensional (2-D) connectivity tables of molecules;
a molecular mechanics module to generate from the 2-D connectivity tables a feature vector comprising both a geometric representation and a topological representation of the molecules, wherein the molecular mechanics module applies a molecular transform and a wavelet transform to the geometric representation to produce geometric wavelet features; and
a computational neural network (CNN) to correlate the geometric wavelet features and topological features of the feature vector with biological endpoints to predict toxicological properties of the molecules,
wherein the feature vector contains geometric wavelet features that identify a molecular structure representation of the molecules and topological connectivity indices that describe electronic structural characteristics of the molecules.

2. The Multi-Intelligent System of claim 1, wherein the CNN evaluates geometric and topological features of the molecules influencing modes of activity to predict at least one among metabolic processes, modes of action, hepatotoxicity, and neurotoxicity.

3. The Multi-Intelligent System of claim 1, wherein the database management module collects and integrates chemical, physiochemical, and toxicological data, and provides the data to the CNN during learning to associate the molecules with corresponding toxicological properties.

4. The Multi-Intelligent System of claim 1, wherein the database management module contains continuous links to knowledge databases including at least one among, genomics, proteomics, metabolomics, metabonomics, liver toxicity, pathology and chemistry databases

5. The Multi-Intelligent System of claim 1, wherein the molecular mechanics module generates Three-Dimensional (3-D) molecular structures from the 2-D connectivity tables and applies a wavelet transform to the 3-D molecular structures to produce the geometric wavelet features.

6. The Multi-Intelligent System of claim 5, wherein the CNN uses 3-D molecular structures based on Quantitative Structural Activity Relationships (QSARs).

7. The Multi-Intelligent System of claim 1, wherein the topological connectivity indices includes atomic indexes to specify bond connectivity and electronic structure characteristics of the molecules.

8. The Multi-Intelligent System of claim 1, wherein the molecular mechanics module uses highly efficient quasi-Newton Raphson techniques combined with a geometric statement function to minimize a universal potential energy function to generate Three-Dimensional (3-D) molecular structures from the 2-D connectivity tables.

9. The Multi-Intelligent System of claim 1, wherein the CNN predicts potential health risks resulting from exposure to new chemicals, materials, and mixtures comprising the molecules.

10. The Multi-Intelligent System of claim 1, wherein CNN processes microarray data to predict gene expression activities for genes exposed to chemical compounds comprising the molecules.

11. The Multi-Intelligent System of claim 1, wherein the CNN predicts at least one among Lipophility, log P, acute inhalation toxicity, Carcinogenic Potency, and mutagenicity in Salmonella.

12. The Multi-Intelligent System of claim 1, wherein the CNN determines structure transport properties of chemical compounds comprising the molecules across a blood-brain-barrier (BBB).

13. A computer-readable storage medium to model biological effects of molecules comprising computer instructions for:
generating a 3-D molecular structure of a molecule from Two-Dimensional (2-D) connectivity tables;
transforming the 3-D molecular structure to produce a geometrical representation of the molecule by applying a molecular transform and a wavelet transform to the 3D molecular structure;
computing bond connectivity and electronic structure characteristics of the molecules to produce a topological representation of the molecule;
generating a feature vector comprising the geometrical representation and the topological representation; and
correlating the feature vector with biological endpoints for predicting toxicological properties of the molecules.

14. The storage medium of claim 13, comprising computer instructions for
computing a first atomic index called a connectivity index that is equal to a number of non-hydrogen atoms to which a given non-hydrogen atom is bonded;
computing a second atomic index called a valence-connectivity index that incorporates details of an electronic configuration for each non-hydrogen atom.

15. The storage medium of claim 13, comprising computer instructions for
calculating aromatic characteristics of the molecule that affect an activity of the molecule by comparing bond lengths of the molecule to an optimal bond length using a bond elongation term, EN, and a bond length alteration term, GEO.

16. The storage medium of claim 13, comprising computer instructions for
assigning confidence limits to neural network models based on training data distribution;
correlating the network output with an independent validation to enable measurement of a degree of accuracy of the neural network models; and
applying statistical techniques to determine whether the degree of accuracy is significant.

17. The storage medium of claim 13, comprising computer instructions for
comparing attributes of outcomes such as physical properties with values obtained from literature or calculated from computational chemistry to determine a prediction accuracy.

18. The storage medium of claim 1, comprising computer instructions for predicting at least one among metabolic rates, modes of action, hepatotoxicity, neurotoxicity, and gene expressions.

19. A method for predicting toxicological effects of molecules, comprising:
obtaining a three-dimensional (3-D) structure of a molecule from a database;
transforming the 3-D structure to a one-dimensional (1-D) geometrical representation using a combination of a molecular transform and wavelet transform;
computing a topology and electronic structure of the molecule via topological indices; and
generating a feature vector comprising the 1-D geometrical representation, the topology and the electronic structure.

20. The method of claim 19, further comprising submitting the feature vector to a neural network to predict a metabolic rates of the molecule at a site of action.

21. The method of claim 19, further comprising submitting the feature vector to a neural network to predict a mode of action of the molecule at a site of action.

22. The method of claim 19, further comprising submitting the feature vector to a neural network to predict whether liver cells exposed to the molecules produce at least one legion type from the group comprising fat, necrosis, cirrhosis, carcinoma, and cholestasis.

23. The method of claim 19, further comprising submitting the feature vector to a neural network to predict whether structural transport properties of a molecule will penetrate a blood brain barrier

24. The method of claim 19, further comprising submitting the feature vector to a neural network to predict whether a gene exposed to the molecule undergoes an induced, repressed, or unchanged level of expression.
